(19) United States
(12) Patent Application Publication
(10) Pub. No.: US 2021/0364900 A1
(43) Pub. Date: Nov. 25, 2021

(54) Projection Method of Projection System for Use to Correct Image Distortion on Uneven Surface

(71) Applicant: WELTREND SEMICONDUCTOR INC., Hsinchu (TW)

(72) Inventors: Ta Hsien, Hsinchu (TW); Ming-Hung Kao, Hsinchu (TW); Meng-Che Tsai, Hsinchu (TW)

(21) Appl. No.: 16/920,414

(22) Filed: Jul. 2, 2020

(30) Foreign Application Priority Data
May 19, 2020 (TW) 109116519

(51) Int. Cl. G03B 21/14

(52) U.S. Cl. CPC G03B 21/147

(57) ABSTRACT

A projection system includes a projector, a depth sensor, an inertia measurement unit and a processor. The depth sensor and the inertia measurement unit are fixed at the projector. A projection method includes the inertia measurement unit performing a 3-axis acceleration measurement to generate an orientation of the projector, the depth sensor detecting a plurality of coordinates of a plurality of points on a projection surface, the processor performing a keystone correction according to at least the plurality of coordinates of the plurality of points on the projection surface to generate a calibrated projection region, the processor generating a set of data according to at least the orientation of the projector, the calibrated projection region and the plurality of coordinates, and the projector projecting a pre-warped image onto the projection surface according to the set of data.

### CROSS REFERENCE TO RELATED APPLICATION

This non-provisional application claims priority of Taiwan patent application No. 109116519, filed on 19th May, 2020, included herein by reference in its entirety.

### BACKGROUND OF THE INVENTION

### 1. Field of the Invention

The invention relates to image processing, and specifically, to projection methods of a projection system.

### 2. Description of the Prior Art

A projector is an optical device that projects an image onto a projection surface. In practice, images on the projection surface may be distorted owing to the projector being tilted or the projector projecting onto an uneven or inclined surface. Conventionally, the projector may adopt a keystone correction by way of manual positioning and observation to achieve the optimal viewing projection correction. When the projection surface is uneven or curved, the traditional method cannot overcome the problem of image distortion. If the projection screen is too large and several projectors are needed for projection, a projection method will further be in need to resolve the problem of distortion correction amid joint projection.

### SUMMARY OF THE INVENTION

According to one embodiment of the invention, a projection method for use in a projection system is provided. The projection system includes a projector, a camera and a processor, the projector and the camera are disposed separately. The projection method includes the projector projecting a projection image onto a projection surface, the camera capturing a display image on the projection surface, the processor generating, according to a plurality of feature points in the projection image and a plurality of corresponding feature points in the display image, a transformation matrix of the plurality of feature points and the plurality of corresponding feature points, the processor pre-warping a set of projection image data according to the transformation matrix to generate a set of pre-warped image data, and the projector projecting a pre-warped image onto the projection surface according to the set of pre-warped image data.

According to another embodiment of the invention, projection method for use in a projection system is disclosed. The projection system includes a projector, a depth sensor, an inertia measurement unit and a processor. The depth sensor and the inertia measurement unit are fixed at the projector. The projection method includes the inertia measurement unit performing a 3-axis acceleration measurement to generate an orientation of the projector, the depth sensor detecting a plurality of coordinates of a plurality of points on a projection surface with respect to a reference point, the processor performing a keystone correction according to at least the plurality of coordinates of the plurality of points on the projection surface to generate a calibrated projection region, the processor generating a set of data corresponding to a 3D-to-2D coordinate projective transformation according to at least the orientation of the projector, the calibrated projection region and the plurality of coordinates, and the projector projecting a pre-warped image onto the projection surface according to the set of data corresponding to the 3D-to-2D coordinate projective transformation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a projection system according to an embodiment of the invention.

FIG. 2 is a flowchart of a projection method of the projection system in FIG. 1.

FIG. 3A is a schematic diagram of the projection image projected by the projector in FIG. 1.

FIG. 3B is a schematic diagram of the display image captured by the camera in FIG. 1.

FIG. 4A is a schematic diagram of a pre-warped image to be displayed according to a set of pre-warped image data generated by the processor in FIG. 1.

FIG. 4B is a display image resulting from projecting the pre-warped image on the projection surface in FIG. 1.

FIG. 5 is a schematic diagram of a projection system according to another embodiment of the invention.

FIG. 6 is a flowchart of a projection method of the projection system in FIG. 5.

FIG. 7 is a schematic diagram of a pinhole camera model.

FIG. 8 is a schematic diagram of a three-dimensional keystone correction method.

FIG. 9 is a schematic diagram of depth sensing using the binocular vision method.

FIG. 10 is a schematic diagram of a projection system according to another embodiment of the invention.

FIG. 11 is a flowchart of a projection method of the projection system in FIG. 10.

FIG. 12 is a schematic diagram of a projection method of the projection system in FIG. 10.

### DETAILED DESCRIPTION

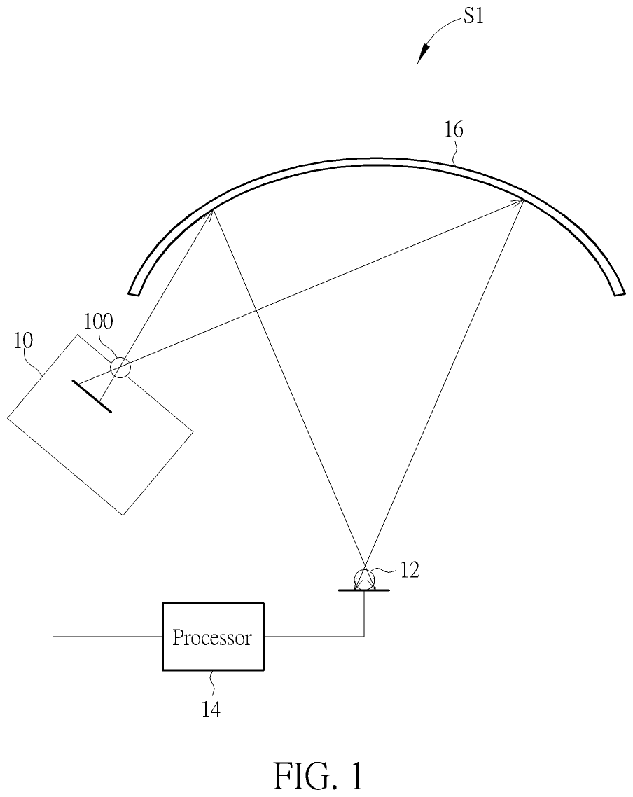

FIG. 1 is a schematic diagram of a projection system S1 according to an embodiment of the invention. The projection system S1 may include a projector 10, a camera 12 and a processor 14. The projector 10 may include a digital light processing device 100. The projector 10 and the camera 12 may be disposed separately, and both may be coupled to the processor 14. The processor 14 may be disposed in the projector 10, the camera 12, a computer, a mobile phone or a game console. The projector 10 may project onto the projection surface 16 via the digital light processing device 100 at an angle. The camera 12 may be disposed on a wall or at other fixtures directly opposite to the projection surface 16 or from the viewer's location. The projection surface 16 may be a flat surface, a curved surface, a corner, a ceiling, a spherical surface or other uneven surfaces. The horizontal viewing angle of the projector 10 may be substantially equal to 40 degrees, the vertical viewing angle of the projector 10 may be substantially equal to 27 degrees, and the tilt angle of the projector 10 may be between plus 45 degrees and minus 45 degrees. The image on the projection surface 16 may be distorted due to a tilt angle of the projector 10 and/or an uneven projection surface 16. In FIG. 1, the projection region of the projector 10 on the projection surface 16 and the image capture region of the camera 12 are equal, but in other embodiments, the projection region of the projector 10 on the projection surface 16 and the image capture region of the camera 12 may not be equal. The projection system S1 may employ a projector method 200 to correct an image distortion, so as to form a corrected image on the projection surface 16 that is perceived by human eyes as rectangular and undistorted.

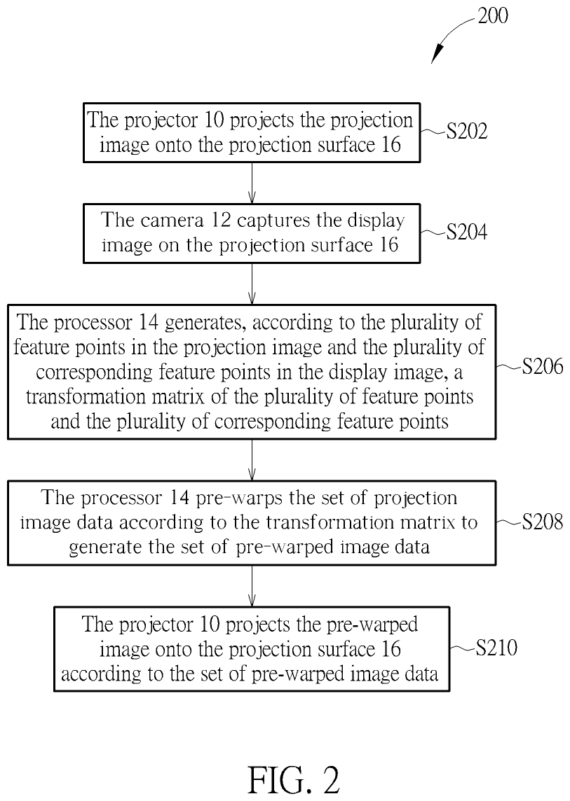

FIG. 2 is a flowchart of a projection method 200 of the projection system S1. The projection method 200 includes Steps S202 to S210. Any reasonable technical changes or step adjustments are within the scope of the present invention. The following details Steps S202 to S210:

Step S202: the projector 10 projects the projection image onto the projection surface 16;

Step S204: the camera 12 captures the display image on the projection surface 16;

Step S206: the processor 14 generates, according to the plurality of feature points in the projection image and the plurality of corresponding feature points in the display image, a transformation matrix of the plurality of feature points and the plurality of corresponding feature points;

Step S208: the processor 14 pre-warps the set of projection image data according to the transformation matrix to generate the set of pre-warped image data;

Step S210: the projector 10 projects the pre-warped image onto the projection surface 16 according to the set of pre-warped image data.

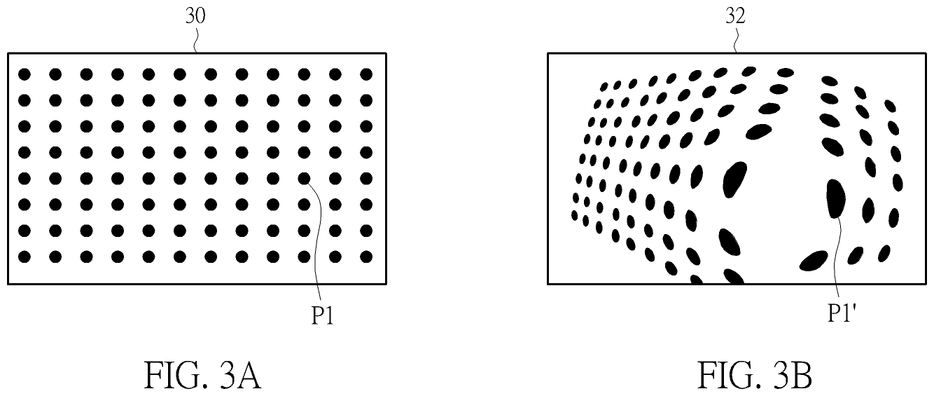

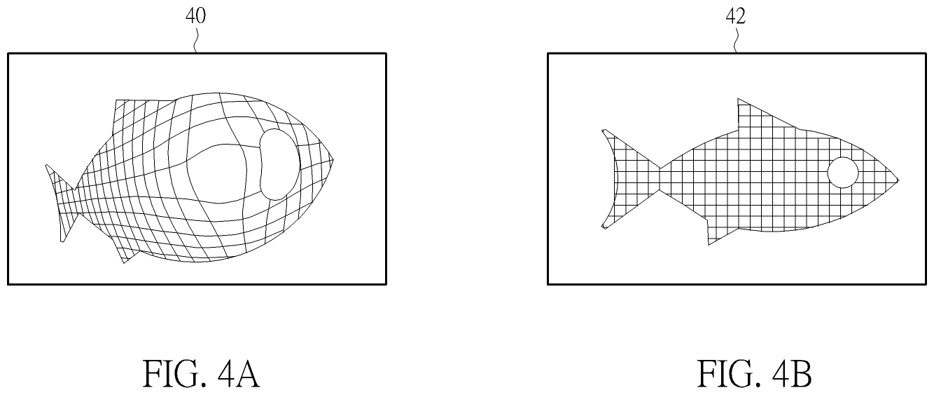

The following embodies Steps S202 to S210 by FIGS. 3A, 3B, 4A and 4B. FIG. 3A is a schematic diagram of the projection image 30 projected by the projector 10, and FIG. 3B is a schematic diagram of the display image 32 captured by the camera 12. The projection image 30 may be an image projected by the digital light processing device 100 and may include a plurality of feature points. The display image 32 may include a plurality of corresponding feature points. For example, the feature point P1 in the projection image 30 may correspond to the feature point P1′ in the display image 32. In Step S202, the projector 10 projects the projection image 30 onto the projection surface 16 via the digital light processing device 100. In Step S204, an image sensor of the camera 12 captures the display image 32 on the projection surface 16. In Step S206, the processor 14 generates, according to the plurality of feature points in the projection image 30 and the plurality of corresponding feature points in the display image 32, the transformation matrix of the plurality of feature points and the plurality of corresponding feature points. For example, for the feature point P1 in the projection image 30, the processor 14 may identify that the feature point P1′ in the display image 32 corresponds to the feature point P1 in the projection image 30, determine that the corresponding feature point P1′ may be rotated in the counterclockwise direction by 30 degrees and shifted to the left by 1 centimeter to arrive the feature point P1, and employ a rotation in the counterclockwise direction by 30 degrees and shifting to the left by 1 centimeter respectively as the rotational transformation parameter and translational transformation parameter. In the same manner, the processor 14 generates a rotational transformation parameter and a translational transformation parameter between each feature point and each corresponding feature point, and stores the rotational transformation vectors and translational transformation vectors between all feature points and all corresponding feature points into the transformation matrix. The processor 14 pre-warps a set of projection image data according to the transformation matrix to generate a set of pre-warped image data. FIG. 4A is a schematic diagram of a pre-warped image 40 to be displayed according to a set of pre-warped image data generated by the processor 14 of the projection system S1 pre-warping a set of projection image data. FIG. 4B is a display image 42 resulting from projecting the pre-warped image 40 on the projection surface 16. In step S208, the processor 14 pre-warps the set of projection image data according to the transformation matrix to generate the set of pre-warped image data. In step S210, the projector 10 projects the pre-warped image 40 onto the projection surface 16 according to the set of pre-warped image data to form the display image 42 on the projection surface 16.

In step S208, the set of projection image data corresponds to the display image 42, since the projection surface 16 is not a flat surface, the set of projection image data must be pre-warped by the transformation matrix to generate the set of pre-warped image data corresponding to the pre-warped image 40, thereby forming the display image 42 on the uneven projection surface 16 without distortion.

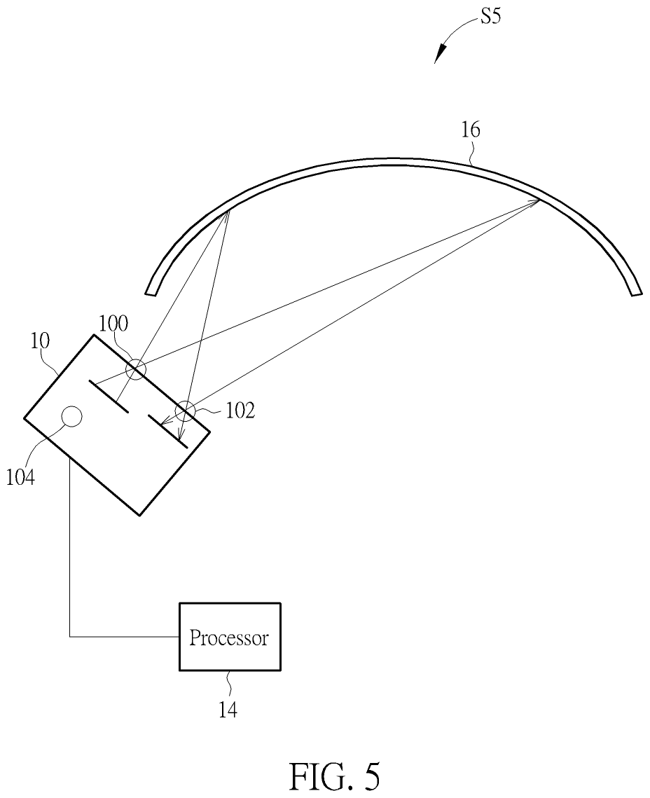

FIG. 5 is a schematic diagram of a projection system S5 according to another embodiment of the invention. The projection system S5 may include a projector 10 and a processor 14. The projector 10 may include a digital light processing device 100, a depth sensor 102, and an inertia measurement unit 104. The depth sensor 102 and the inertia measurement unit 104 may be fixed anywhere at the projector 10 and may be coupled to the processor 14. In some embodiments, the depth sensor 102 may be provided separately from the projector 10. The location of the depth sensor 102 with respect to the reference point may be measured in advance. The reference point may be set at the position of the depth sensor 102, at the focal point of the projection lens of the projector 10, or between the depth sensor 102 and the focal point. The processor 14 may be disposed in the projector 10, in a computer, a mobile phone or a game console. The projector 10 may project onto the projection surface 16 via the digital light processing device 100 at an angle. The projection surface 16 may be a flat surface, a curved surface, a corner, a ceiling, a spherical surface or other uneven surfaces. The horizontal viewing angle of the projector 10 may be substantially equal to 40 degrees, the vertical viewing angle of the projector 10 may be substantially equal to 27 degrees, and the tilt angle of the projector 10 may be between plus 45 degrees and minus 45 degrees. The image on the projection surface 16 may be distorted due to a tilt angle of the projector 10 and/or an uneven projection surface 16. In FIG. 5, the projection region of the projector 10 and the sensing region of the depth sensor 102 on the projection surface 16 are equal, but in other embodiments, the projection region of the projector 10 and the sensing region of the depth sensor 102 on the projection surface 16 may not be equal.

The inertia measurement unit 104 may be an accelerometer, a gyroscope, or other rotation angle sensing devices. The inertia measurement unit 104 may perform a three-axis acceleration measurement to generate an orientation of the projector 10. The orientation of the projector 10 includes the three-dimensional rotation angles of the projector 10, and the three-dimensional rotation angles may be expressed in quaternion angles, Rodrigues' rotation formula, or Euler angles. The depth sensor 102 may be a camera, a 3-dimensional time-of-flight (3D ToF) sensor, or other devices that can detect multi-point distances on an object so as to detect a configuration of the projection surface 16. The processor 14 may correct the distortion resulting from the tilt angle of the projector 10 according to the orientation of the projector 10, and may perform a keystone correction according to the configuration of the projection surface 16 to correct the distortion resulting from the configuration of the projection surface 16, enabling the digital light processing device 100 to generate a pre-warped image for the projector 10 to form a display image on the projection surface 16 perceived by the human eye as rectangular and undistorted.

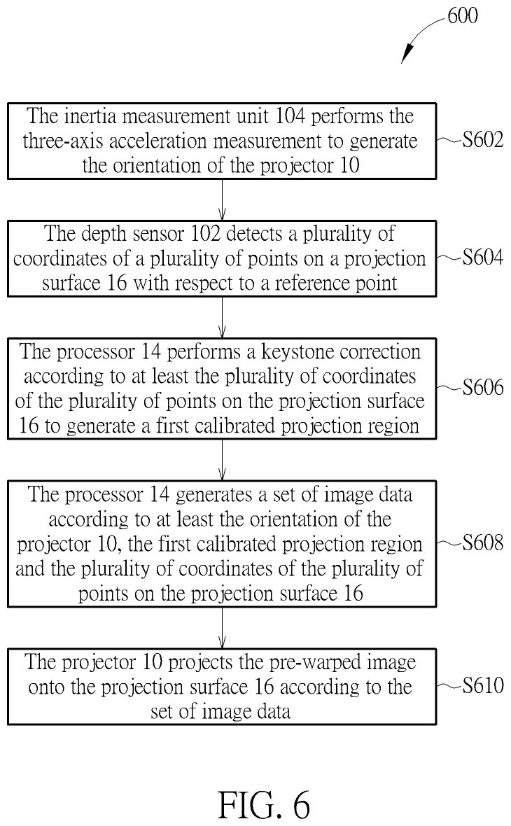

The projection system S5 may employ a projection method 600 to correct an image distortion. FIG. 6 is a flowchart of a projection method 600 of the projection system S5. The projection method 600 includes Steps S602 to S610. Any reasonable technical changes or step adjustments are within the scope of the present invention. The following details Steps S602 to S610:

Step S602: the inertia measurement unit 104 performs the three-axis acceleration measurement to generate the orientation of the projector 10;

Step S604: the depth sensor 102 detects a plurality of coordinates of a plurality of points on a projection surface 16 with respect to a reference point;

Step S606: the processor 14 performs a keystone correction according to at least the plurality of coordinates of the plurality of points on the projection surface 16 to generate a first calibrated projection region;

Step S608: the processor 14 generates a set of image data according to at least the orientation of the projector 10, the first calibrated projection region and the plurality of coordinates of the plurality of points on the projection surface 16;

Step S610: the projector 10 projects the pre-warped image onto the projection surface 16 according to the set of image data.

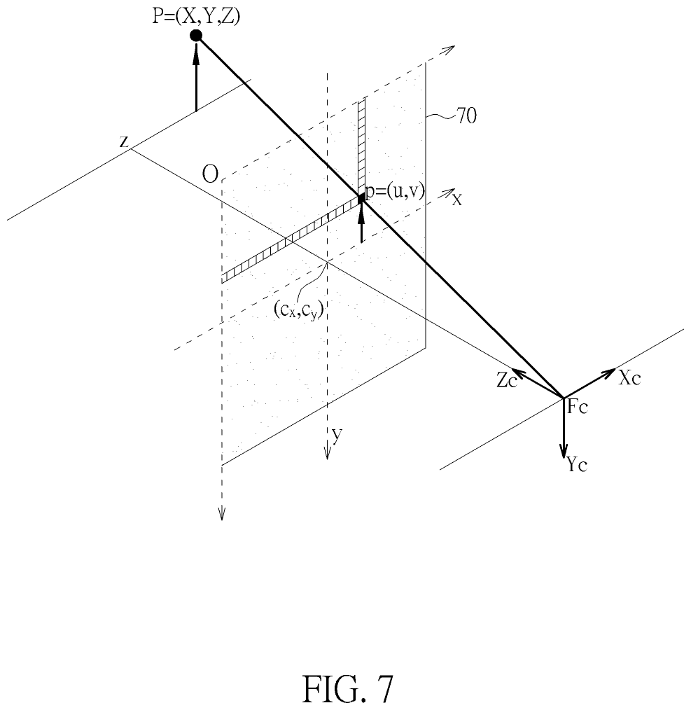

The projection method 600 may be described by a pinhole camera model. FIG. 7 is a schematic diagram of a pinhole camera model. When the pinhole camera model is applied to the projector 10, the plane 70 may be the image plane of the digital light processing device 100, the center point (cₓ, c_{y}) of the image plane 70 may be an principle point, and the point Fc may be the focal point of the projection lens of the projector 10, the distance from the focal point to the image plane may be referred to as the focal length, the point P may be the ideal focal point on the projection surface 16, and the point p may be a point where a line from the ideal focal point P to the focal point Fc intersecting the image plane 70, i.e., the point p is the pre-warped image point on the image plane 70. The ideal focal point P may be represented by the coordinates (X, Y, Z) in the world coordinate system, and the pre-warped image point p may be represented by the coordinates (u, v) in the image plane coordinate system. The reference point of the world coordinate system may be set at the depth sensor 102, at the focal point Fc of the projector 10, or between the focal point Fc of the projector 10 and the depth sensor 102. The reference point of the image plane coordinate system may be set at point O. The reference point of the camera coordinate system may be set at the focal point Fc defined by the x-axis, y-axis and z-axis. The transformation between the ideal focal point P(X, Y, Z) on the projection surface 16 and the pre-warped image point p(u, v) on the image plane 70 may be expressed by perspective transformation Equation (1):

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] \qquad Equation ( 1 )$$

where s is a normalized scalar factor;
(u, v) are two-dimensional coordinates in the image plane 70;
(X, Y, Z) are three-dimensional coordinates on the projection surface 16;

$$[ \begin{matrix}{f}_{x} & 0 & {c}_{x} \\ 0 & {f}_{y} & {c}_{y} \\ 0 & 0 & 1\end{matrix} ]$$

is referred to as an intrinsic parameter matrix;

$$[ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

is referred to as an extrinsic parameter matrix, including a rotational transformation matrix

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

and a translational transformation matrix

$$[ \begin{matrix}{t}_{1} \\ {t}_{2} \\ {t}_{3}\end{matrix} ] ;$$

fₓ is the focal length in the x-axis direction;
f_{y} is the focal length in the y-axis direction;
cₓ is the x coordinate of a principle point;
c_{y} is the y coordinate of the principle point;
r₁₁ to r₃₃ are rotational transformation vectors; and
t₁ to t₃ are translational transformation vectors.

According to Equation (1), the pre-warped image point p(u, v) on the image plane 70 may be generated by the intrinsic parameter matrix, the extrinsic parameter matrix, and the ideal focal point P(X, Y, Z) on the projection surface 16. The intrinsic parameter matrix contains a set of fixed internal projector parameters. For a single focal length of projector 10, the intrinsic parameter matrix is fixed. The extrinsic parameter matrix may be generated by the orientation of the projector 10, and the ideal focal point P(X, Y, Z) on the projection surface 16 may be generated by the configuration of the projection surface 16.

In Step S602, The inertia measurement unit 104 performs the three-axis acceleration measurement to generate the orientation of the projector 10. In this embodiment, the orientation of the projector 10 may be expressed by the Euler angles θₓ, θ_{y}, θ_{z}, or may be expressed in other ways.

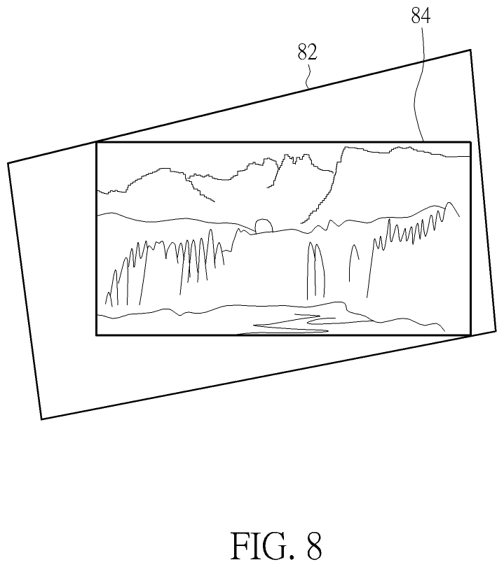

In Step S604, the depth sensor 102 detects a plurality of three-dimensional coordinates of a plurality of points on the projection surface 16 with respect to the reference point to obtain the configuration of the projection surface 16. The configuration of the projection surface 16 may be defined by the plurality of three-dimensional coordinates of the plurality of points on the projection surface 16. The reference point may be set at the depth sensor 102, at the focal point Fc of the projection lens of the projector 10, or between the depth sensor 102 and the focal point Fc. Since the projection surface 16 may be an uneven surface, the projection region of the projector 10 on the projection surface 16 may be affected by the configuration of the projection surface 16 and may be non-rectangular in shape. Therefore, in Step S606, the processor 14 performs the three-dimensional keystone correction according to the configuration of the projection surface 16, so as to generate a corrected projection region on the projection surface 16. Specifically, the processor 14 may determine the projection region of the projector 10 on the projection surface 16 according to the plurality of coordinates of the plurality of points on the projection surface 16 and the horizontal viewing angle and the vertical viewing angle of the projector 10, and determine a rectangular region within the projection region as a corrected projection region. The rotation angle of the rectangular region with respect to the horizontal line may be 0 degrees. The corrected projection region may be defined by the three-dimensional space coordinates on the projection surface 16. In some embodiments, the corrected projection region may be the largest rectangular region within the projection region. In other embodiments, the corrected projection region may be the largest rectangular region with a predetermined aspect ratio within the projection region. For example, the predetermined aspect ratio of the rectangular region may be 4:3, 16:9, or other ratios. FIG. 8 is a schematic diagram of a three-dimensional keystone correction method, which includes the projection region 82 of the projector 10 and the corrected projection region 84. In the embodiment, the configuration of the projection surface 16 is an inclined plane, and the projection region 82 of the projector 10 is non-rectangular. The processor 14 determines the projection region 82 according to the configuration of the projection surface 16 and the horizontal viewing angle and the vertical viewing angle of the projector 10, and determines the maximum rectangular region with a predetermined aspect ratio of 16:9 in the projection region 82 as the corrected projection region 84. Both the projection region 82 and the corrected projection region 84 may be defined by the three-dimensional spatial coordinates on the projection surface 16. Although the embodiment shows a flat configuration of the projection surface 16, the configuration of the projection surface 16 may also be an uneven surface. When the configuration of the projection surface 16 is an uneven surface, the processor 14 may determine the projection region 82 in a similar manner, and crop the maximum rectangular region with a predetermined aspect ratio from the projection region 82 as the corrected projection region 84.

In step S608, the processor 14 generates the extrinsic parameter matrix according to the orientation of the projector 10. The processor 14 may generate the rotational transformation matrix of the extrinsic parameter matrix according to the Euler angles θₓ, θ_{y}, θ_{z}. The rotational transformation matrix includes a set of three-axis rotational transformation vectors r₁₁ to r₃₃, as expressed by Equation (2):

$$\begin{matrix} & Equation ( 2 ) \\ [ \begin{matrix}{r}_{11} & {r}_{12} & {r}_{13} \\ {r}_{21} & {r}_{22} & {r}_{23} \\ {r}_{3 l} & {r}_{32} & {r}_{33}\end{matrix} ] = [ \begin{matrix}cos {θ}_{y} & 0 & sin {θ}_{y} \\ 0 & 1 & 0 \\ - s in {θ}_{y} & 0 & cos {θ}_{y}\end{matrix} ] [ \begin{matrix}1 & 0 & 0 \\ 0 & cos {θ}_{x} & - s in {θ}_{x} \\ 0 & sin {θ}_{x} & cos {θ}_{x}\end{matrix} ] [ \begin{matrix}cos {θ}_{z} & - s in {θ}_{z} & 0 \\ sin {θ}_{z} & cos {θ}_{z} & 0 \\ 0 & 0 & 1\end{matrix} ] & \end{matrix}$$

The processor 14 may generate translational transformation vectors t₁ to t₃ according to the location of the depth sensor 102 with respect to the reference point. When the reference point of the world coordinate system is set at the focal point Fc of the projector 10, or between the focal point Fc of the projector 10 and the depth sensor 102, the translational transformation vectors t₁ to t₃ are fixed in values, resulting in a fixed translational transformation matrix of the extrinsic parameter matrix. When the reference point of the world coordinate system is set at the depth sensor 102, the translational transformation vectors t₁ to t₃ are all 0, the transformation between the ideal focal point P(X, Y, Z) on the projection surface 16 and the pre-warped image points p(u, v) on the image plane 70 may be expressed by Equation (3):

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}X \\ Y \\ Z\end{matrix} ] \qquad Equation ( 3 )$$

The extrinsic parameter matrix only contains a set of three-axis rotational transformation vectors r₁₁ to r₃₃.

In Step S608, the processor 14 further generates the ideal focal point P(X, Y, Z) on the projection surface 16 according to the coordinates of the corrected projection region 84 and the complex points of the projection surface 16. In some embodiments, the processor 14 may fit the projection image data to the plurality of coordinates of the plurality of points on the projection surface 16 in the corrected projection region 84 to obtain a plurality of ideal focal points. Then the processor 14 substitutes the intrinsic parameter matrix, the extrinsic parameter matrix and the plural ideal focal points into Equation (1) or Equation (3) to obtain a set of images data of the plurality of pre-warped image points in the pre-warped image on the image plane 70. The set of image data is the corresponding data of transforming three-dimensional spatial data into two-dimensional image coordinates.

Finally, in Step S610, the projector 10 projects the pre-warped image onto the projection surface 16 according to the set of image data, so as to form the corrected projection image on the projection surface 16 that is perceived by the human eye as rectangular and undistorted.

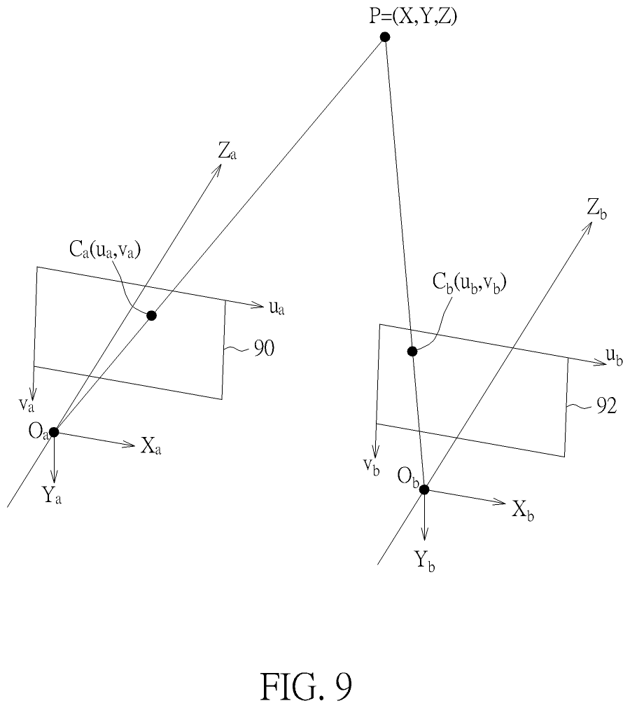

In some embodiments, in step S604, the configuration of the projection surface 16 may be detected by a binocular vision method. When the binocular vision method is used, the depth sensor 102 may be a camera. The camera may have a high resolution and may be suitable for detecting a projection surface 16 having a complicated configuration, such as a curved projection surface 16. The binocular vision method simulates how the scene is processed by human eyes. Specifically, the binocular vision method includes observing the same feature point on the projection surface 16 from two locations, obtaining from each location a two-dimensional image of the same feature point, and then performing a matching operation according to the image data of the respective two-dimensional images to reconstruct the three-dimensional coordinates of the object. The three-dimensional coordinates contain the depth information of the object, thereby generating the configuration of the projection surface 16. The projection system S5 employs the projector 10 and the depth sensor 102 as two image capture devices in the binocular vision method to acquire two-dimensional images of the same feature point from two locations. The projector 10 projects the first projection image onto the projection surface 16, the camera receives the reflected image reflected from the projection surface 16, and the processor 14 generates the plurality of points on the projection surface 16 with respect to the reference point according to the first projection image and the reflected image, so as to define the configuration of the projection surface 16. The first projection image may include a plurality of calibration spots or other correction patterns. FIG. 9 is a schematic diagram of depth detection using the binocular vision method, where 90 may be the image plane of the digital light processing device 100 of the projector 10, and 92 may be the image plane of the camera's image sensor. A feature point P(X, Y, Z) on the projection surface 16 corresponds to a projection point Cₐ(uₐ, vₐ) on the image plane of the digital light processing device 100, a projection point C_{b}(u_{b}, v_{b}) is on the image plane of the image sensor, the focal point of the projector 10 is Oₐ, the focal point of the camera is O_{b}, the extrinsic parameter matrix of the digital light processing device 100 is Pₐ, and the extrinsic parameter matrix of the image sensor is P_{b}, respectively expressed by Equation (4) and Equation (5):

$$\begin{matrix}{P}_{a} = [ \begin{matrix}{r}_{11}^{a} & {r}_{12}^{a} & {r}_{13}^{a} & {t}_{1}^{a} \\ {r}_{21}^{a} & {r}_{22}^{a} & {r}_{23}^{a} & {t}_{2}^{a} \\ {r}_{31}^{a} & {r}_{32}^{a} & {r}_{33}^{a} & {t}_{3}^{a}\end{matrix} ] & Equation ( 4 ) \\ {P}_{b} = [ \begin{matrix}{r}_{11}^{b} & {r}_{12}^{b} & {r}_{13}^{b} & {t}_{1}^{b} \\ {r}_{2 l}^{b} & {r}_{22}^{b} & {r}_{23}^{b} & {t}_{2}^{b} \\ {r}_{31}^{b} & {r}_{32}^{b} & {r}_{33}^{b} & {t}_{3}^{b}\end{matrix} ] & Equation ( 5 )\end{matrix}$$

where r₁₁^{a} to r₃₃^{a} are the rotational transformation vectors of the digital light processing device 100, t₁^{a} to t₃^{a} are the translational transformation vectors of the digital light processing device 100, r₁₁^{b} to r₃₃^{b} are the rotational transformation vectors of the image sensor, and t₁^{b} to t₃^{b} are the translational transformation vectors of the image sensor. According to Equation (1), the pinhole camera model Equation (6) and Equation (7) of the digital light processing device 100 and the image sensor can be obtained respectively as follows:

$$\begin{matrix}{Z}_{w}^{a} [ \begin{matrix}{u}_{a} \\ {v}_{a} \\ 1\end{matrix} ] = [ \begin{matrix}{f}_{x}^{a} & 0 & {c}_{x}^{a} \\ 0 & {f}_{y}^{a} & {c}_{y}^{a} \\ 0 & 0 & 1\end{matrix} ] {P}_{a} [ \begin{matrix}X \\ Y \\ Z \\ 1\end{matrix} ] & Equation ( 6 ) \\ {Z}_{w}^{b} [ \begin{matrix}{u}_{b} \\ {v}_{b} \\ 1\end{matrix} ] = [ \begin{matrix}{f}_{x}^{b} & 0 & {c}_{x}^{b} \\ 0 & {f}_{y}^{b} & {c}_{y}^{b} \\ 0 & 0 & 1\end{matrix} ] {P}_{b} [ \begin{matrix}X \\ Y \\ Z \\ 1\end{matrix} ] & Equation ( 7 )\end{matrix}$$

Substitute Equation (4) into Equation (6) to obtain Equation (8):

r₁₁^{a}X+r₁₂^{a}Y+r₁₃^{a}Z+t₁^{a}−r₃₁^{a}uₐX−r₃₂^{a}uₐY−r₃₃^{a}uₐZ=t₃^{a}uₐ

r₂₁^{a}X+r₂₂^{a}Y+r₂₃^{a}Z+t₂^{a}−r₃₁^{a}vₐX−r₃₂^{a}vₐY−r₃₃^{a}vₐZ=t₃^{a}vₐ Equation (8)

Substitute Equation (5) into Equation (7) to obtain Equation (9):

r₁₁^{b}X+r₁₂^{b}Y+r₁₃^{b}Z+t₁^{b}−r₃₁^{b}u_{b}X−r₃₂^{b}u_{b}Y−r₃₃^{b}u_{b}Z=t₃^{b}u_{b}

r₂₁^{b}X+r₂₂^{b}Y+r₂₃^{b}Z+t₂^{b}−r₃₁^{b}v_{b}X−r₃₂^{b}v_{b}Y−r₃₃^{b}v_{b}Z=t₃^{b}v_{b} Equation (9)

Geometrically, Equation (8) and Equation (9) represent the line from the focal point Oₐ to the feature point P and the line from the focal point O_{b} to the feature point P, respectively, and the intersection of the two lines is the solution of the three-dimensional coordinates (X, Y, Z) of the feature point P. The processor 14 may generate a plurality of three-dimensional coordinates of the plurality of feature points on the projection surface 16 according to the plurality of projection points on the image plane of the digital light processing device 100 and the plurality of corresponding projection points on the image plane of the image sensor, thereby defining the configuration of the projection surface 16.

In some other embodiments, in Step S604, the configuration of the projection surface 16 may be detected using a time-of-flight ranging method. When the three-dimensional time-of-flight method is used, the depth sensor 102 may be a three-dimensional time-of-flight sensor. Compared to the camera, the 3D time-of-flight distance sensor may have a lower resolution and a faster detection speed, and may be suitable for detecting the projection surface 16 with a simple configuration, such as a flat projection surface 16. The three-dimensional time-of-flight method may include obtaining distances between the feature point P of an object in a specific field of view (FoV) and the three-dimensional time-of-flight sensor, and forming a plane by 3 arbitrary points, so as to derive the configuration of the projection surface 16. When the three-dimensional time-of-flight method is used, the three-dimensional time-of-flight sensor transmits a transmission signal to the projection surface 16, and receives a reflection signal reflected by the projection surface 16 in response to the transmission signal, and the processor 14 generates the plurality of coordinates of the plurality of points on the projection surface 16 with respect to the reference point according to time difference between the transmission signal and the reflection signal, thereby defining the configuration of the projection surface 16.

The projection system S5 and the projection method 600 employ a depth sensor and an inertia measurement unit fixed at the projector to generate the orientation of the projector and to detect the configuration of the projection surface, correct distortion owing to the tilted projector according to the orientation of the projector, perform the keystone correct according to the configuration of the projection surface to correct the distortion owing to the configuration of the projection surface, thereby pre-warping the image, so as to project the pre-warped image onto the projection surface to form the corrected projection image that is rectangular and free of distortion.

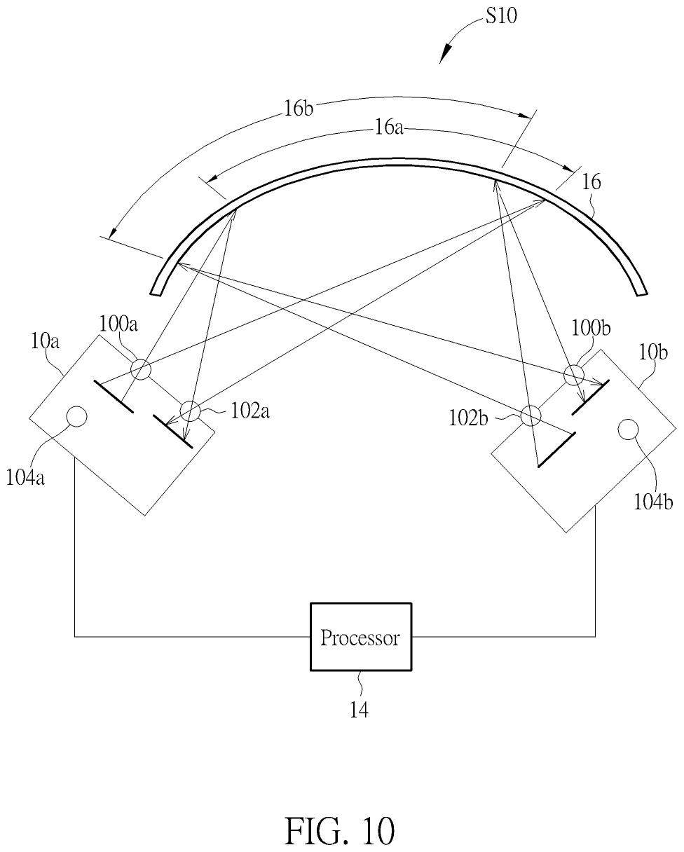

FIG. 10 is a schematic diagram of a projection system S10 according to another embodiment of the invention. The projection system S10 may include a first projector 10a, a second projector 10b and a processor 14. The first projector 10a and the second projector 10b can be coupled to the processor 14. The first projector 10a may include a first digital light processing device 100a, a first depth sensor 102a and a first inertia measurement unit 104a. The second projector 10b may include a second digital light processing device 100b, a second depth sensor 102b and a second inertia measurement unit 104b. The arrangement and connection of all components of the first projector 10a and the second projector 10b are similar to those of the projector 10 in FIG. 5 and will not be repeated here. The first inertia measurement unit 104a may detect the configuration of a first projection surface 16a, and the second inertia measurement unit 104b may detect the configuration of a second projection surface 16b. The configuration of the first projection surface 16a may be defined by a plurality of coordinates of a plurality of points on the first projection surface 16a with respect to the first reference point, and the configuration of the second projection surface 16b may be defined by a plurality of coordinates of a plurality of points on the second projection surface 16b with respect to the second reference point. While the embodiment uses both the first inertia measurement unit 104a and the second inertia measurement unit 104b to detect different parts of the projection surface 16, one of the first inertia measurement unit 104a and the second inertia measurement unit 104b may be removed from the projection system S10, and the remaining inertia measurement unit may adopt a large detection region to simultaneously cover the detection of both the configurations of the first projection surface 16a and the second projection surface 16b.

The projection system S10 is different from the projection system S5 in that the projection surface 14 may perform the keystone correction according to the configuration of the first projection surface 16a and the configuration of the second projection surface 16b to generate the first calibrated projection region and a second calibrated projection region. In some embodiments, a distance between the first projector 10a and the second projector 10b may be measured in advance, the processor 14 may perform the keystone correction according to the distance between the first projector 10a and the second projector 10b, the configuration of the first projection surface 16a and the configuration of the second projection surface 16b to generate the first corrected projection region and the second corrected projection region. For image correction of the first projector 10a, the processor 14 may generate a first pre-warped image according to the orientation of the first projector 10a, the plurality of coordinates of the plurality of points on the first projection surface 16a with respect to the first reference point, for the first projector 10a to project the first pre-warped image onto the first projection surface 16a to form a first corrected projection image that is free of distortion. Similarly, for image correction of the second projector 10b, the processor 14 may generate a second pre-warped image according to the orientation of the second projector 10b, the plurality of coordinates of the plurality of points on the second projection surface 16b with respect to the second reference point, for the second projector 10b to project the second pre-warped image onto the second projection surface 16b to form a second corrected projection image that is free of distortion. In some embodiments, the first projection 10a and the second projector 10b may project the first pre-warped image and the second pre-warped image onto the first corrected projection region and the second corrected projection region respectively to perform an image blending process, so as to project the first pre-warped image and the second pre-warped image onto the uneven projection surface 16 to display a rectangular and distortion-free corrected projection image. The image blending process may be a gradient blending process.

While the embodiment uses two projectors for projection, the projection system S10 can also use more than two projectors to co-project on the projection surface 16 in a similar manner to produce a rectangular and distortion-free corrected projection image.

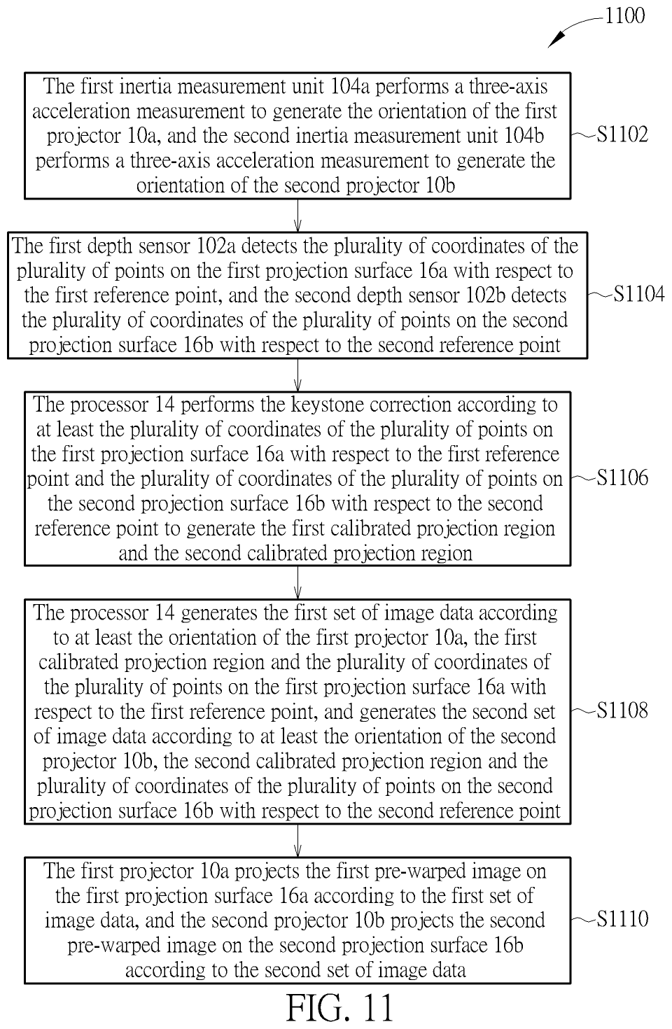

FIG. 11 is a flowchart of a projection method 1100 of the projection system S10. The projection method 1100 includes Steps S1102 to S1110. Any reasonable technical changes or step adjustments are within the scope of the present invention. The following details Steps S1102 to S1110:

Step S1102: the first inertia measurement unit 104a performs a three-axis acceleration measurement to generate the orientation of the first projector 10a, and the second inertia measurement unit 104b performs a three-axis acceleration measurement to generate the orientation of the second projector 10b;

Step S1104: the first depth sensor 102a detects the plurality of coordinates of the plurality of points on the first projection surface 16a with respect to the first reference point, and the second depth sensor 102b detects the plurality of coordinates of the plurality of points on the second projection surface 16b with respect to the second reference point;

Step S1106: the processor 14 performs the keystone correction according to at least the plurality of coordinates of the plurality of points on the first projection surface 16a with respect to the first reference point and the plurality of coordinates of the plurality of points on the second projection surface 16b with respect to the second reference point to generate the first calibrated projection region and the second calibrated projection region;

Step S1108: the processor 14 generates the first set of image data according to at least the orientation of the first projector 10a, the first calibrated projection region and the plurality of coordinates of the plurality of points on the first projection surface 16a with respect to the first reference point, and generates the second set of image data according to at least the orientation of the second projector 10b, the second calibrated projection region and the plurality of coordinates of the plurality of points on the second projection surface 16b with respect to the second reference point;

Step S1110: the first projector 10a projects the first pre-warped image on the first projection surface 16a according to the first set of image data, and the second projector 10b projects the second pre-warped image on the second projection surface 16b according to the second set of image data.

The description of step S1102 to step S1110 may be found in the previous paragraph, and will not be repeated here. The projection method 1100 is suitable for a multi-projection system S10. The projection method 1100 employs corresponding inertia measurement units fixed at the respective multiple projectors to correct the distortions resulting from tilts of the multiple projectors, employs the corresponding depth sensors of the cameras to detect the configurations of the corresponding projection surfaces to perform the keystone correction, so as to correct the distortion due to the configurations of corresponding projection surfaces, and then pre-warps the images to project the corresponding pre-warped images that are rectangular and distortion-free projection images onto the corresponding projection surfaces.

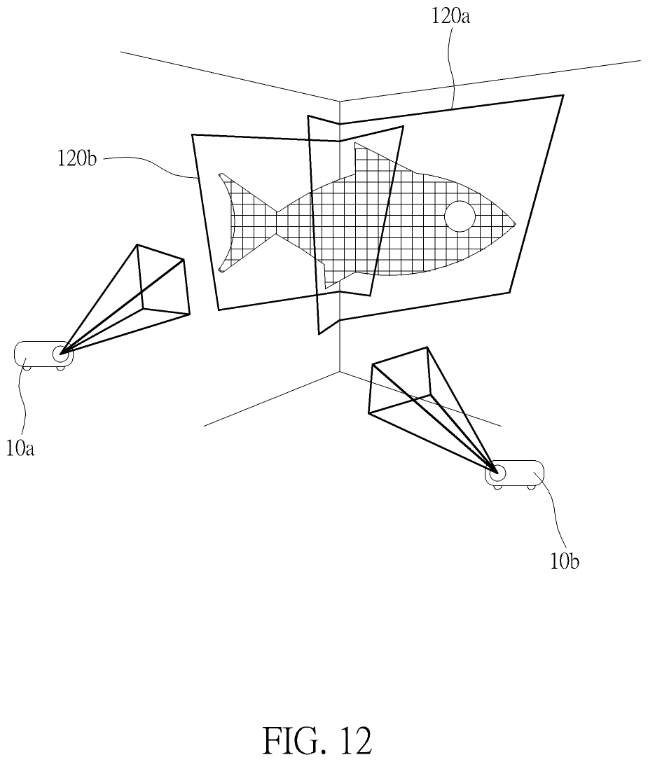

FIG. 12 is a schematic diagram of a projection method of the projection system S10, where the projection surface is a corner. The first projector 10a and the second projector 10b project the first pre-warped image and the second pre-warped image onto the first corrected projection region 120a and the second corrected projection region 120b, respectively. The first pre-warped image and the second pre-warped image may form a complete pre-warped image. The first pre-warped image and the second pre-warped image may be projected to the corner, forming in the first corrected projection region and the second corrected projection region the first corrected projection image and the second corrected projection image free of distortions, respectively. The overlapping portions of the first corrected projection image and the second corrected projection image may be blended to enhance the quality of the projection image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection method for use in a projection system, the projection system comprising a projector, a camera and a processor, the projector and the camera being disposed separately, the projection method comprising:
the projector projecting a projection image onto a projection surface;
the camera capturing a display image on the projection surface;
the processor generating, according to a plurality of feature points in the projection image and a plurality of corresponding feature points in the display image, a transformation matrix of the plurality of feature points and the plurality of corresponding feature points;
the processor pre-warping a set of projection image data according to the transformation matrix to generate a set of pre-warped image data; and
the projector projecting a pre-warped image onto the projection surface according to the set of pre-warped image data.

2. A projection method for use in a projection system, the projection system comprising a first projector, a first depth sensor, an first inertia measurement unit and a processor, the first depth sensor and the first inertia measurement unit being fixed to the first projector, the projection method comprising:
the first inertia measurement unit performing a three-axis acceleration measurement to generate an orientation of the first projector;
the first depth sensor detecting a plurality of coordinates of a plurality of points on a first projection surface with respect to a first reference point;
the processor performing a keystone correction according to at least the plurality of coordinates of the plurality of points on the first projection surface to generate a first calibrated projection region;
the processor generating a first set of image data according to at least the orientation of the first projector, the first calibrated projection region and the plurality of coordinates; and
the first projector projecting a first pre-warped image onto the first projection surface according to the first set of image data.

3. The projection method of claim 2, wherein the first reference point is a position of the first depth sensor.

4. The projection method of claim 2, wherein the processor generating the first set of image data according to at least the orientation of the first projector, the first calibrated projection region and the plurality of coordinates comprises:
the processor generating the first set of image data according to the orientation of the first projector, a location of the first depth sensor with respect to the first reference point, the first calibrated projection region and the plurality of coordinates.

5. The projection method of claim 4, wherein the first reference point is a focal point of the first projector.

6. The projection method of claim 4, wherein the first reference point is between the first depth sensor and a focal point of the first projector.

7. The projection method of claim 2, wherein the orientation of the first projector comprises a set of three-axis rotational transform parameters of the first projector.

8. The projection method of claim 2, wherein the first depth sensor is a camera, and the first depth sensor detecting the plurality of coordinates of the plurality of points on the first projection surface with respect to the first reference point comprises:
the first projector projecting a first projection image onto a first projection surface;
the camera capturing a display image on the first projection surface; and
the processor generating the plurality of coordinates of the plurality of points on the first projection surface with respect to the first reference point according to the first projection image and the display image.

9. The projection method of claim 2, wherein the first depth sensor is a three-dimensional time of flight (3D ToF) sensor, and the first depth sensor detecting the plurality of coordinates of the plurality of points on the first projection surface with respect to the first reference point comprises:
the three-dimensional time-of-flight sensor transmitting a transmission signal to the first projection surface;
the three-dimensional time-of-flight sensor receiving a reflected signal reflected from the first projection surface in response to the transmitted signal; and
the processor generating, according to the transmitted signal and the reflected signal, the plurality of coordinates of the plurality of points on the first projection surface with respect to the first reference point.

10. The projection method of claim 2, wherein the processor performing the keystone correction according to at least the plurality of coordinates of the plurality of points on the first projection surface to generate the first calibrated projection region comprises:
the processor determining a projection region projected by the first projector on the first projection surface according to the plurality of coordinates of the plurality of points on the first projection surface with respect to the first reference point; and
the processor employing a rectangular region within the projection region as the first calibrated projection region.

11. The projection method of claim 10, wherein the processor employing the rectangular region within the projection region as the first calibrated projection region comprises:
the processor determining a maximum rectangular region within the projection region according to a predetermined aspect ratio, and employing the maximum rectangular region as the first calibrated projection region.

12. The projection method of claim 2, wherein:
the first projection system further comprises a second projector, a second depth sensor and a second inertia measurement unit;
the second depth sensor and the second inertia measurement unit are fixed to the second projector;
the projection method further comprises:
the second inertia measurement unit performing a three-axis acceleration measurement to generate an orientation of the second projector;
the second depth sensor detecting a plurality of coordinates of a plurality of points on a second projection surface with respect to a second reference point;
the processor performing the keystone correction according to at least the plurality of coordinates of the plurality of points on the first projection surface to generate the first calibrated projection region comprises:
the processor performing the keystone correction according to the plurality of coordinates of the plurality of points on the first projection surface with respect to the first reference point and the plurality of coordinates of the plurality of points on the second projection surface with respect to the second reference point to generate the first calibrated projection region; and
the projection method further comprises:
the processor performing a keystone correction according to the plurality of coordinates of the plurality of points on the first projection surface with respect to the first reference point and the plurality of coordinates of the plurality of points on the second projection surface with respect to the second reference point to generate a second calibrated projection region;
the processor generating a second set of image data according to at least the orientation of the second projector, the second calibrated projection region and the plurality of coordinates of the plurality of points on the second projection surface with respect to the second reference point; and
the second projector projecting a second pre-warped image onto the second projection surface according to the second set of image data.

13. The projection method of claim 12, wherein the second reference point is a position of the second depth sensor.

14. The projection method of claim 12, wherein the processor generating the second set of image data according to at least the orientation of the second projector, the second calibrated projection region and the plurality of coordinates of the plurality of points on the second projection surface with respect to the second reference point comprises:
the processor generating the second set of image data according to the orientation of the second projector, a location of the second depth sensor with respect to the second reference point, the second calibrated projection region and the plurality of coordinates of the plurality of points on the second projection surface with respect to the second reference point.

15. The projection method of claim 14, wherein the second reference point is a focal point of the second projector.

16. The projection method of claim 14, wherein the second reference point is between the second depth sensor and a focal point of the second projector.

17. The projection method of claim 2, wherein the projection surface is an uneven surface.
